(19) United States
(12) Patent Application Publication
(10) Pub. No.: US 2024/0002609 A1
(43) Pub. Date: Jan. 4, 2024

(54) SOLUTION OF SULFONE POLYMERS IN N-TERT.-BUTYL-2-PYRROLIDONE FOR THE USE OF MEMBRANES

(71) Applicant: BASF SE, Ludwigshafen am Rhein (DE)

(72) Inventors: Oliver GRONWALD, Ludwigshafen (DE); Radoslaw Kierat, Ludwigshafen (DE); Tatjana Huber, Ludwigshafen (DE)

(73) Assignee: BASF SE, Ludwigshafen am Rhein (DE)

(21) Appl. No.: 18/254,857

(22) PCT Filed: Nov. 22, 2021
(86) PCT No.: PCT/EP2021/082449

§ 371 Date: May 28, 2023

(30) Foreign Application Priority Data
Nov. 30, 2020 (EP) 20210689.4
May 18, 2021 (EP) 21174349.7

(51) Int. Cl. C08J 3/09; C08L 81/06; B01D 67/00; B01D 71/68

(52) U.S. Cl. CPC C08J 3/096; C08L 81/06; B01D 67/0016; B01D 67/0081; B01D 2325/30; B01D 2221/12; B01D 2323/21823; B01D 2323/2187; B01D 2325/24; B01D 71/68

(57) ABSTRACT

A solution contains at least one sulfone polymer and N-tert.-butyl-2-pyrrolidone. The solution can be used in a process of making a membrane, which is useful for water treatment.

The present invention relates to a solution comprising at least one sulfone polymer and N-tert.-butyl-2-pyrrolidone, the process of making a membrane and the use of this membrane for water treatment.

Sulfone polymers such as polysulfone, polyethersulfone and polyphenylenesulfone are high performance polymers which are used in a variety of technical applications because of their mechanical properties and their chemical and thermal stability. Sulfone polymers, however, have limited solubility in many common solvents. In particular low molecular weight fractions of sulfone polymers cause turbidity of solutions of sulfone polymers, as described by J. G Wijmans and C. A. Smolders in Eur. Polym. J. 19, No. 12, pp 1143 to 1146 (1983).

U.S. Pat. No. 5,885,456 discloses N-methyl-2-pyrrolidone (NMP), N,N-dimethylacetamide (DMAC), dimethylacrylamide (DMAD) or dimethylsulfoxide (DMSO) as suitable solvent for sulfone polymers. Most of these solvents listed in U.S. Pat. No. 5,885,456 are reprotoxic solvents which will be exchanged by non-reprotoxic solvents in the future with hopefully the same properties like the preferred solvents in the past.

One major technical application is the use of sulfone polymers as raw materials for the production of membranes, for example ultrafiltration membranes (UF membranes), as described in U.S. Pat. Nos. 4,207,182 and 5,885,456. The process of producing membranes of sulfone polymers includes dissolving sulfone polymers in a solvent, coagulating the sulfone polymer from such solvent and further post-treatment steps. The selection of the solvent is essential to the process and has impact on the properties of the obtained membrane, including but not limited to the membranes' mechanical stability, water permeability and size of pores.

S. Savarier et. al describe in Desalination 2002, 144, 15-20 that insoluble crystalline cyclic polysulfone dimers pose in solutions for membrane manufacturing problems either by filter clogging or can cause imperfections on the membrane surface.

S. Munari et. al outline in Desalination 1988, 70, 265-275 that for common solvents such as NMP, DMAc, N,N-dimethylforamide (DMF) and dimethylsulfoxide (DMSO) polysulfone solutions in these solvents are difficult to cast due to their low viscosity resulting from the low molecular weight of the polysulfones. To overcome this problem it has become common practice to dissolve water soluble polymers such as polyvinylpyrrolidone together with polysulfone polymers to increase the solution viscosity.

EP-A 2804940 describes the use of N-n-butyl-2-pyrrolidone as well as of N-tert.-butyl-2-pyrrolidone as non-reprotoxic solvent for the polymer production of different kind of polymers such as polysulfons, polyethersulfons and polyvinylpyrrolidons. A polymer solution comprising a sulfone polymer and N-tert.-butyl-2-pyrrolidone (TBP) as solvent which shows higher solution viscositiy as the sulfone polymer solution with other solvents as cited in the state of the art as well as the use of N-tert.-butyl-2-pyrrolidone (TBP) as solvent in a solution comprising a sulfone polymer and a water soluble polymer or an additive for making a membrane with better mechanical stability is not disclosed in EP-A 2804940.

In the field of solvents there is an ongoing demand for alternative solvents which may replace presently used solvents in specific applications. In case of sulfone polymers alternative solvents should be able to prepare solutions that allow a high content of sulfone polymer without turbidity. Regarding membranes made there from it is important that at least the same standard of membrane quality and possibly an even better membrane quality is achieved. In particular, the water permeability of such membranes should be as high as possible combined with no defects or macrovoids visible in the cross-section of the membrane. Furthermore, stable polymer solution comprising the sufone polymer, a water soluble polymer and/or an additive and the solvent influences the building of pores of the membrane. Therefore, a solvent which is able to stable the sulfone polymer solution and which causes fewer clogging of not solved dimers causes a better pore morphology in the cross-section of the membrane and a longer life time of the membrane as these are more mechanical stable.

It was an object of the present invention to provide an alternative solvent for sulfone polymers and for the process of making membranes. The alternative solvent should fulfill the requirements listed above.

Accordingly, the solution as defined above and a process for the making of membranes have been found.

To the sulfone polymer

The solution comprises a sulfone polymer. The term “sulfone polymer” shall include a mixture of different sulfone polymers.

A sulfone polymer comprises —SO2- units in the polymer, preferably in the main chain of the polymer.

Preferably, the sulfone polymer comprises at least 0.02 mol —SO2- units, in particular at least 0.05 mol —SO2- units per 100 grams (g) of polymer. More preferred is a sulfone polymer comprising at least 0.1 mol —SO2- units per 100 g of polymer. Most preferred is a sulfone polymer comprising at least 0.15 mol —SO2- units, in particular at least 0.2 mol —SO2- units per 100 g of polymer.

Usually a sulfone polymer does comprise at maximum 2 mols —SO2- units, in particular at maximum 1.5 mols of —SO2- units per 100 grams (g) of polymer. More preferred is a sulfone polymer comprising at maximum 1 mol of —SO2- units per 100 grams of polymer. Most preferred is a sulfone polymer comprising at maximum 0.5 mols of —SO2- units per 100 grams of polymer. Preferably, the sulfone polymer comprises aromatic groups, shortly referred to as an aromatic sulfone polymer.

In a preferred embodiment, the sulfone polymer is an aromatic sulfone polymer, which comprises at least 20% by weight, in particular to at least 30% by weight of aromatic carbon atoms based on the total weight amount of the sulfone polymer. An aromatic carbon atom is a carbon atom, which is part of an aromatic ring system.

More preferred is an aromatic sulfone polymer, which comprises at least 40% by weight, in particular to at least 45% by weight of aromatic carbon atoms based on the total weight amount of the sulfone polymer.

Most preferred is an aromatic sulfone polymer, which comprises at least 50% by weight, in particular to at least 55% by weight of aromatic carbon atoms based on the total weight amount of the sulfone polymer.

Preferably, the sulfone polymer may comprise aromatic groups that are selected from 1,4-phenylene, 1,3-phenylene, 1,2-phenylene, 4,4′-biphenylene, 1,4-naphthylene and 3-chloro-1,4-phenylene.

The aromatic groups may be linked by, for example, units selected from —SO2-, —SO—, —S—, —O—, —CH2-, —C(CH3)2.

In a preferred embodiment, the sulfone polymer comprises at least 80% by weight, particular at least about 90% by weight, more preferably at least 95% and most preferably at least 98% by weight of groups selected from the above aromatic groups and linking groups based on the total weight amount of the sulfone polymer.

Examples of most preferred sulfone polymers are:
polyethersulfone of formula I

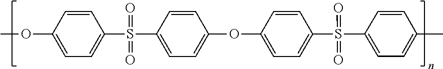

with n≥2, which is, for example, available from BASF under the trade name Ultrason® E, polysulfone of formula II

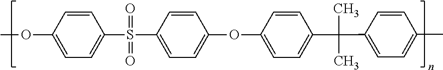

with n≥2, which is, for example, available from BASF under the trade name Ultrason® S and polyphenylsulfone of formula III

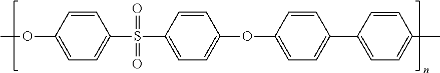

with n≥2, which is, for example, available from BASF under the trade name Ultrason® P.

The viscosity number (V.N.) for the preferred sulfone polymers usable for the inventive solution as well as for the inventive process of making membranes may range from 50 to 120 ml/g, preferably from 60 to 100 ml/g. The V.N. is measured according to ISO 307 in 0.01 g/mol phenol/1,2 orthodi-chlorobenzene 1:1 solution.

The average molecular weights Mw of the preferred sulfone polymers are in the range of 40000 to 95000 g/mol, more preferably 50000 to 70000 g/mol. The preferred sulfone polymers Ultrason® E having weight average molecular weights Mw in the range of 48000 to 92000 g/mol, UItrason® S having weight average molecular weights Mw in the range of 52000 to 70000 g/mol and Ultra-son® P having weight average molecular weights Mw in the range of 40000 to 60000 g/mol. The Mw is measured according to gel permeation chromatography in tetrahydrofuran with polystyrene as standard. Ultrason® E, Ultrason® S and Ultrason® P are commercially available from BASF SE.

To the Water Soluble Polymers

The water soluble polymer helps to adjust the viscosity of the solution. The main purpose of the water solution polymer is to support the formation of the pores. In the coagulation step during the process of making the membrane the water soluble polymer becomes distributed in the coagulated membrane and thus becomes the place holder for pores.

The water soluble polymer may be any known water soluble polymer selected from the group of polyvinyl pyrrolidone and polyalkylene oxides with a molar mass of 8000 g/mol or higher. Preferred water soluble polymers are selected from the group of polyvinyl pyrrolidone, polyethylene oxide, polypropylene oxide, polyethylene oxide/polypropylene oxide block copolymers and mixtures thereof with a molar mass of 8000 g/mol or higher. A more preferred water soluble polymer is polyvinyl pyrrolidone and polyalkylene oxides with a molar mass of 8000 g/mol or higher and a solution viscosity characterised by the K-value of 25 or higher determined according to the meth-od of Fikentscher described by Fikentscher in Cellulosechemie 13, 1932 (58). As very preferred water soluble polymer are polyvinyl pyrrolidones with a molar mass of 8000 g/mol or higher and a solution viscosity characterised by the K-value of 25 or higher determined according to the meth-od of Fikentscher described by Fikentscher in Cellulosechemie 13, 1932 (58).

To the Solution

The solution may comprise further additives. These additives are selected from the group of C2-C4 alkanol, C2-C4 alkanediol, C3-C4 alkanetriol, polyethylene glycol with a molar mass in the range of 100 to 1000 g/mol, polyalkylene oxides with a molar mass in the range of 100 to 1000 and mixtures of those. Preferred additives are ethanol, n-propanol, iso-propanol, n-butanol, isobutanol, tert-butanol, ethylene glycol, 1,1-ethandiol, 1,2-propandiol, 1,3-propandiol, 2,2-propandiol, 1,2,3-propantriol, 1,1,1-propantriol, 1,1,2-propantriol, 1,2,2-propantriol, 1,1,3-propantriol, 1,1,1-butantriol, 1,1,2-butantriol, 1,1,3-butantriol, 1,1,4-butantriol, 1,2,2,-butantriol, 2,2,3-butantriol, 2-methyl-1,1,1-triolpropan, 2-methyl-1,1,2-triolpropan, 2-methyl-1,2,3-triolpropan, 2-methyl-1,1,3-triol-propan, polyethylene oxide, polypropylene oxide, polyethylene oxide/polypropylene oxide block copolymers and mixtures thereof with a molar mass of the polyalkylenoxide in the range of 100 to 1000. g/mol.

In a preferred embodiment up to 20 wt.-%, in particular up to 15 wt. %, based on the total weight amount of the solution is an additive.

In a more preferred embodiment the amount of additive is in the range of 0.1 to 12 wt. %, in particular 5 to 12 wt.-% based on the total weight amount of the solution.

The solution may comprise further solvents besides the N-tert.-butyl-2-pyrrolidone, hereinafter referred to as co-solvents.

Preferred are co-solvents that are miscible with the N-tert.-butyl-2-pyrrolidone in any ratio. Suitable co-solvents are, for example, selected from high-boiling ethers, esters, ketones, asymmetrically halogenated hydrocarbons, anisole, gamma-valerolactone, dimethylformamide, dimethyl sulfoxide, sulfolane, N-methyl-2-pyrrolidone, N-ethyl-2-pyrrolidone, N-n-butyl-2-pyrrolidone, N,N-dimethyl-2-hydroxypropanoic amide and N,N-diethyl-2-hydroxypropanoic amide.

In a preferred embodiment at least 10% by weight, in particular at least 90% by weight of the total weight amount of all solvents of the solution is N-tert.-butyl-2-pyrrolidone.

In a most preferred embodiment no co-solvent is used in the solution and N-tert.-butyl-2-pyrrolidone is the only solvent used.

Preferably, the solution comprises 5 to 50 parts by weight, in particular 10 to 40 wt.-%, more preferably 20 to 35 wt.-%, of sulfone polymer per 100 wt.-% of the total amount of all solvents.

In a most preferred embodiment the solution comprises 5 to 50 wt.-%, in particular 10 to 40 wt. %, more preferably 20 to 35 wt.-% of sulfone polymer per 100 wt.-% of the total amount of N-tert-butyl-2-pyrrolidone.

Preferably, the inventive solution comprises 1 to 40 wt.-%, in particular 10 to 30 wt.-%, more preferably 15 to 25 wt.-% of sulfon polymer according to the total weight amount of the solution. In a most preferred embodiment the inventive solution comprises 0.1 to 15 wt.-%, in particular 1 to 10 wt.-%, more preferably 5 to 10 wt.-% of water soluble polymers according to the total weight amount of the solution.

The solution may be prepared by adding the sulfone polymer, the water soluble polymer and/or the additive to the N-tert.-butyl-2-pyrrolidone and dissolving the sulfone polymer according to any process known in the art. The dissolution process may be supported by increasing the temperature of the solution and/or by mechanical operations like stirring. In an alternative embodiment the sulfone polymer may be already synthesized in N-tert.-butyl-2-pyrrolidone or a solvent mixture comprising N-tert.-butyl-2-pyrrolidone.

To the Process of Making a Membrane

In the context of this application a membrane shall be understood to be a semipermeable structure capable of separating two fluids or separating molecular and/or ionic components or particles from a liquid. A membrane acts as a selective barrier, allowing some particles, substances or chemicals to pass through, while retaining others. The membrane may have various geometries such as flat sheet, spiral wound, pillows, tubular, single bore hollow fiber or multiple bore hollow fiber.

For example, membranes can be reverse osmosis (RO) membranes, forward osmosis (FO) membranes, nanofiltration (NF) membranes, ultrafiltration (UF) membranes or microfiltration (MF) membranes. These membrane types are generally known in the art and are in detail described in literature. A good overview is found also in earlier EP-A 3349887 which is here with incorporated herein by reference. A preferred membrane is the ultrafiltration (UF) membrane.

Membranes may be produced according to a process comprising the following steps:
a) providing a solution comprising a sulfone polymer, N-tert-butyl-2-pyrrolidone and further comprising a water soluble polymer and/or an additive,
b) contacting the solution with a coagulant
c) optionally oxidizing and washing the obtained membrane

The solution in step a) corresponds to the solution described above. The water soluble polymer helps to adjust the viscosity of the solution. The main purpose of the water solution polymer is to support the formation of the pores. In the following coagulation step b) the water soluble polymer becomes distributed in the coagulated membrane and thus becomes the place holder for pores.

The water soluble polymer may be any known water soluble polymer. Preferred water soluble polymers are selected from the group of polyvinyl pyrrolidone and polyalkylene oxide with a molar mass of 8000 g/mol or higher. More preferred water soluble polymers are selected from the group of polyvinyl pyrrolidone, polyethylene oxide, polypropylene oxide, polyethylene oxide/polypropylene oxide block copolymers and mixtures thereof with a molar mass of 8000 g/mol or higher. A much more preferred water soluble polymer is polyvinyl pyrrolidone and polyalkylene oxides with a molar mass of 8000 g/mol or higher and a solution viscosity characterised by the K-value of 25 or higher determined according to the method of Fikentscher described by Fikentscher in Cellulosechemie 13, 1932 (58). As very preferred water soluble polymer are polyvinyl pyrrolidones with a molar mass of 8000 g/mol or higher and a solution viscosity characterised by the K-value of 25 or higher determined according to the method of Fikentscher described by Fikentscher in Cellulosechemie 13, 1932 (58).

In a preferred embodiment, the solution in step a) comprises 50 to 90 wt.-% of the sulfone polymer and 10 to 50 wt.-% of the water soluble polymer and/or additives, based on the total weight amount of the sulfone polymer, water soluble polymer and/or additives.

Preferably, the solution comprises 50 to 70 wt.-% of the sulfon polymer and 30 to 50 wt.-% of the water soluble polymer and/or additive based on the total weight of the sulfon polymer, water soluble polymer and/or additive.

The solution may optionally be degassed before proceeding to the next step.

In step b) the solution is contacted with a coagulant. In this step coagulation of the sulfon polymer occurs and the membrane structure is formed.

The sulfon polymer should have low solubility in the coagulant. Suitable coagulants are, for example, liquid water, water vapor and mixtures thereof with alcohols and/or co-solvents or solvent (N-tert-butyl-2-pyrrolidone). Suitable alcohols are, for example, mono-, di- or trialkanols selected from the group of the group of C2-C4 alkanol, C2-C4 alkanediol, C3-C4 alkanetriol, polyethylene oxide with a molar mass of 100 to 1000 g/mol as they can be used as additives in the inventive solution. Suitable co-solvents are selected from high-boiling ethers, esters, ketones, asymmetrically halogenated hydrocarbons, anisole, gamma-Valerolactone, dimethylformamide, dimethyl sulfoxide, sulfolane, N-methyl-2-pyrrolidone, N-ethyl-2-pyrrolidone, N-n-butyl-2-pyrrolidone, N,N-dimethyl-2-hydroxypropanoic amide and N,N-diethyl-2-hydroxypropanoic amide. Preferred coagulants are mixtures comprising liquid water and the solvent N-tert.-butyl-2-pyrrolidone or mixtures comprising liquid water and alcohols, e.g. polyethylene oxide with a molar mass of 100 to 1000 g/mol and/or mixtures comprising liquid water and co-solvents, in particular (gamma-valerolactone). Said coagulants may comprise from 10 to 90 wt.-% water and 90 to 10 wt.-% alcohol and/or co-solvent(s) or solvent, preferably 30 to 70 wt.-% water and 70 to 30 wt. % alcohol and/or co-solvent(s) or solvent, based on the total weight of the coagulant. As a general rule the total amount of all components of the coagulant does not exceeds 100%. More preferred are coagulants comprising liquid water and the solvent N-tert.-butyl-2-pyrrolidone or coagulants comprising liquid water/alcohols mixtures, in particular mixtures of water and polyethylene oxide with a molar mass of 100 to 1000 g/mol that were optionally used as additive in the inventive solution or gamma-valerolactone/water mixtures, wherein the coagulant comprises 30 to 70 wt.-% water and 70 to 30 wt.-% N-tert.-butyl-2-pyrrolidone or alcohol and/or (gamma-valerolactone) based on the total weight of the coagulant. Most preferred is liquid water as coagulant.

Further details of process steps a) and b) depend on the desired geometrical structure of the membrane and the scale of production, which includes lab scale or commercial scale.

For a flat sheet membrane detailed process steps a) and b) could be as follows:
a1) adding the water soluble polymer and/or additive to the solution comprising a sulfon polymer and N-tert.-butyl-2-pyrrolidone
a2) heating the solution until a viscous solution is obtained; typically the solution is kept at a temperature of 20 to 100° C., preferably 40 to 80° C., more preferably 50 to 60° C.
a3) further stirring of the solution until a homogenous mixture is formed; typically homogenization is finalized within 1 to 10 h, preferably within 1 to 2 hours
b1) Casting the solution obtained in a3) on a support and thereafter transferring the casted film into a coagulation bath, which is preferably water.

For the production of single bore hollow fiber or multiple bore hollow fibers step b1) may performed by extruding the solution obtained in a3) through an extrusion nozzle with the required number of hollow needles. The coagulating liquid is injected through the hollow needles into the extruded polymer during extrusion, so that parallel continuous channels extending in extrusion direction are formed in the extruded polymer. Preferably the pore size on an outer surface of the extruded membrane is controlled by bringing the outer surface after leaving the extrusion nozzle in contact with a mild coagulation agent such that the shape is fixed without active layer on the outer surface and subsequently the membrane is brought into contact with a strong coagulation agent.

Further process step c) is optional. In one embodiment any of the above prepared membrane is oxidized and washed in step c). For oxidation any oxidant may be used. Preferred is a water-soluble oxidant such as e.g. sodium hypochlorite or halogens, especially chlorine in concentration range from 500 to 5000 ppm, more preferred from 1000 to 4000 ppm and most preferred from 1500 to 3000 ppm.

Oxidation as well as washing is performed in order to remove the water-soluble polymer(s) and to form the pores. Oxidation may be followed by washing or vice versa. Oxidation and washing may as well be performed simultaneously in one step. Preferably, the membrane is oxidized with hypochloride solution or chlorgas and subsequently washed with water and in a further step washed with sodium bisulfite solution, preferably 30 to 60 ppm aqueous sodium bisulfite solution.

The inventive solution comprising the sulfone polymer and N-tert.-butylpyrrolidone shows no or at least less turbidity under 5 NTU. The solutions are suitably for the manufacturing of membranes. Membranes obtained have high mechanical stability and have excellent separation characteristics. In particular, membranes have good molecular weight cutoffs (MWCO) in the range of 10 to 100 kDa combined with better values for the water permeability (PWP) in view of the solution viscosity as those mentioned in the art.

The membranes obtained by the process of the invention may be used for any separation purpose, for example water treatment applications, treatment of industrial or municipal waste water, desalination of sea or brackish water, dialysis, plasmolysis, food processing.

### EXAMPLES

Abbreviations and compounds used in the examples:
PWP pure water permeation
MWCO molecular weight cutoff
NTU nephelometric turbidity unit
TBP N-tert.-butyl-2-pyrrolidone
NMP N-methyl-2-pyrrolidone
NBP N-n-butyl-2-pyrrolidone
DMF N,N-dimethylformamide
2P 2-pyrrolidone
12PD 1,2-propandiol
Ultrason® E 3010 Polyethersulfone with a viscosity number (ISO 307, 1157, 1628; in 0.01 g/mol phenol/1,2 orthodichlorobenzene 1:1 solution) of 66; a glass transition temperature (DSC, 10° C./min; according to ISO 11357-1/-2) of 225° C.; a molecular weight Mw (GPC in THF, PS standard): 58000 g/mol, Mw/Mn=3.3
Ultrason® P 3020 P Polyphenylenesulfone with a viscosity number (ISO 307, 1157, 1628; in 0.01 g/mol phenol/1,2 orthodichlorobenzene 1:1 solution) of 71; a glass transition temperature (DSC, 10° C./min; according to ISO 11357-1/-2) of 220° C.; a molecular weight Mw (GPC in THF, PS standard): 48000 g/mol, Mw/Mn=2.7
Ultrason® S 6010 Polysulfone with a viscosity number (ISO 307; in 0.01 g/mol phenol/1,2 orthodichlorobenzene 1:1 solution) of 81; a glass transition temperature (DSC, 10° C./min; according to ISO 11357-1/-2) of 187° C.; a molecular weight Mw (GPC in THF, PS standard): 60000 g/mol, Mw/Mn=3.7
Luvitec® K30 Polyvinylpyrrolidone with a MW of greater than 28000 g/mol and a solution viscosity characterised by the K-value of 30, determined according to the method of Fikentscher (Fikentscher, Cellulosechemie 13, 1932 (58))
Luvitec® K90 Polyvinylpyrrolidone with a MW of greater than 900000 g/mol and a solution viscosity characterised by the K-value of 90, determined according to the method of Fikentscher (Fikentscher, Cellulosechemie 13, 1932 (58))
Pluriol® 400E Polyethylene oxide with an average molecular weight of 400 g/mol cal culated from the OH numbers according to DIN 53240.
Pluriol® 9000E Polyethylene oxide with a solution viscosity characterised by the K-value of 33, determined according to the method of Fikentscher (Fikentscher, Cellulosechemie 13, 1932 (58)) and a molecular weight Mw (GPC in water with 0.01 mol phosphate buffer pH 7.4, TSKgel GMPWXL column, Tosoh Bioscience with poly(ethylene oxide) standard 106-1522000 g/mol): 10800 g/mol.
Breox® 75W55000 Polyethyleneoxide-polypropyleneoxide copolymer with a solution vis cosity characterised by the K-value of 42, determined according to the method of Fikentscher (Fikentscher, Cellulosechemie 13, 1932 (58)) and a molecular weight Mw (GPC in water with 0.01 mol phosphate buffer pH 7.4, TSKgel GMPWXL column, Tosoh Bioscience with poly(ethylene oxide) standard 106-1522000 g/mol): 14300 g/mol

The polymer solution turbidity was measured with a turbidimeter 2100AN (Hach Lange GmbH, Dusseldorf, Germany) employing a filter of 860 nm and expressed in nephelometric turbidity units (NTU). Low NTU values are preferred.

The polymer solution viscosity was measured with a Brookfield Viscometer DV-I Prime (Brookfield Engineering Laboratories, Inc. Middleboro, USA) with RV 6 spindle at 60° C. with 20 to 100 rpm.

The pure water permeance (PWP) of the membranes was tested using a pressure cell with a diameter of 74 mm using ultrapure water (salt-free water, filtered by a Millipore UF-system) at 23° C. and 1 bar water pressure. The pure water permeation (PWP) is calculated as follows (equation 1):

$$PWP = \frac{m}{A \times P \times t} \qquad ( 1 )$$

PWP: pure water permeance [kg/bar h m²]
m: mass of permeated water [kg]
A: membrane area [m²]
P: pressure [bar]
t: time of the permeation experiment [h].
A high PWP allows a high flow rate and is desired.

In a subsequent test, solutions of polyethylene oxide-standards with increasing molecular weight were used as feed to be filtered by the membrane at a pressure of 0.15 bar. By GPC-measurement of the feed and permeate, the molecular weight of the permeate of each polyethylene oxide-standard used was determined. The weight average molecular weight (MW) cut-off of the membranes (MWCO) is the molecular weight of the first polyethylene oxide standard which is withhold to at least 90% by the membrane. For example, a MWCO of 18400 means that PEG of molecular weight of 18400 g/mol and higher are withhold to at least 90%. It is desired to have a MWCO in the range from 10 to 100 kDa.

Tensile testing was carried out according DIN Iso 527-3 and the membranes characterized with Emodulus (Emod in MPa) and strain at break (strain in %).

Preparation of membranes using TBP as polymer solvent

General Procedure

Into a three-neck flask equipped with a magnetic stirrer there were added 65 to 80 ml of Solvent S1, 16.3 to 25 g Ultrason® polymer with optional water soluble polymers 6 to 8 g Luvitec® polyvinylpyrrolidone or polyalkyleneoxide (Pluriol® 9000 E, Breox® 75W55) and with optional additives (1,2-propandiol, Pluriol® 400 E) as given in tables 1-6. The mixture was heated under gentle stirring at 60° C. until a homogeneous clear viscous solution, usually referred to as solution was obtained. The solution was degassed overnight at room temperature.

After that the membrane solution was reheated at 60° C. for 2 hours and casted onto a glass plate with a casting knife (300 microns) at 60° C. using an Erichsen Coating machine (Coatmaster 510, Erichsen GmbH & Co KG, Hemer, Germany) operating at a speed of 5 mm/s. The membrane film was allowed to rest for 30 seconds before immersion in a water-based coagulation bath at 25° C. for 10 minutes. After the membrane had detached from the glass plate, the membrane was carefully transferred into a water bath for 12 h.

Optionally afterwards the membrane was transferred into a bath containing 2000 ppm NaOCI at 60° C. and pH9.5 for 2 h. The membrane was then washed with water at 60° C. and one time with a 0.5 wt.-% solution of sodium bisulfite to remove active chlorine (Posttreatment A).

Or optionally the membrane was washed with water at 60° C. three times (Posttreatment B). Polymer solutions produced with TBP according to the invention show higher solution viscosity and membranes fabricated thereof showed improved mechanical stability (higher Emodulus) over membranes known from the art.

TABLE 1
Compositions and properties of Ultrason ® E 3010
solutions; turbidity@RT [NTU], Visco@60° C. [Pas],

| example | E3010 | Solvent S1 | | Visco | NTU |
|---|---|---|---|---|---|
| example 1 | 25 g | 75 | g TBP | 4.8 | 0.40 |
| comp. ex. 1 | 25 g | 75 | g NMP | 1.0 | 0.81 |

TABLE 2
Compositions and properties of Ultrason ® E 3010 membranes
prepared; MWCO in [kDa], PWP in [kg/h m2 bar], Visco@60°
C. [Pas], Emodulus [MPa], Strain@break [%] Posttreatment
A (NaOCl). Coagulation water-glycerol (50/50 wt/wt).

| | | | | | Solvent | | | | | Strain |
|---|---|---|---|---|---|---|---|---|---|---|
| example | E3010 | K30 | K90 | 12PD | S1 | Visco | PWP | MWCO | Emod | @break |
| example | 19 g | 6 g | 0 g | 10 g | 65 g | 4.8 | 1200 | 77.9 | 183 ± 5 | 20 ± 1 |
| 2 | | | | | TBP | | | | | |
| example | 19 g | 3 g | 3 g | 10 g | 65 g | 18.2 | 870 | 64.6 | 172 ± 6 | 26 ± 3 |
| 3 | | | | | TBP | | | | | |
| example | 19 g | 2 g | 4 g | 10 g | 65 g | 31.2 | 820 | 52.5 | 174 ± 3 | 22 ± 1 |
| 4 | | | | | TBP | | | | | |
| example | 19 g | 1 g | 5 g | 10 g | 65 g | 39.0 | 660 | 41.3 | 161 ± 4 | 16 ± 4 |
| 5 | | | | | TBP | | | | | |
| example | 19 g | 0 g | 6 g | 10 g | 65 g | 83.3 | 570 | 42.0 | 157 ± 5 | 20 ± 3 |
| 6 | | | | | TBP | | | | | |
| comp. | 19 g | 6 g | 0 g | 10 g | 65 g | 1.2 | 65 | 15.9 | 133 ± 11 | 24 ± 5 |
| ex. 2 | | | | | NMP | | | | | |
| comp. | 19 g | 3 g | 3 g | 10 g | 65 g | 5.6 | 1100 | 53.3 | 151 ± 10 | 35 ± 3 |
| ex. 3 | | | | | NMP | | | | | |
| comp. | 19 g | 2 g | 4 g | 10 g | 65 g | 8.0 | 1300 | 65.1 | 150 ± 11 | 25 ± 7 |
| ex. 4 | | | | | NMP | | | | | |
| comp. | 19 g | 1 g | 5 g | 10 g | 65 g | 10.7 | 1200 | 41.0 | 151 ± 4 | 29 ± 4 |
| ex. 5 | | | | | NMP | | | | | |
| comp. | 19 g | 0 g | 6 g | 10 g | 65 g | 13.7 | 1200 | 35.7 | 147 ± 2 | 48 ± 3 |
| ex. 6 | | | | | NMP | | | | | |
| comp. | 19 g | 6 g | 0 g | 10 g | 65 g | 3.4 | 370 | 50.0 | 131 ± 12 | 10 ± 3 |
| ex. 7 | | | | | NBP | | | | | |
| comp. | 19 g | 3 g | 3 g | 10 g | 65 g | 14.2 | 1700 | 46.5 | 131 ± 7 | 9 ± 2 |
| ex. 8 | | | | | NBP | | | | | |
| comp. | 19 g | 2 g | 4 g | 10 g | 65 g | 21.5 | 1300 | 62.9 | 158 ± 8 | 19 ± 8 |
| ex. 9 | | | | | NBP | | | | | |
| comp. | 19 g | 1 g | 5 g | 10 g | 65 g | 30.0 | 1600 | 63.5 | 150 ± 2 | 29 ± 7 |
| ex. 10 | | | | | NBP | | | | | |
| comp. | 19 g | 0 g | 6 g | 10 g | 65 g | 53.0 | 1500 | 66.3 | 137 ± 2 | 35 ± 3 |
| ex. 11 | | | | | NBP | | | | | |

The use of TBP as solvent for the production of the membranes causes formation of more stable membranes even at low viscosity amount e.g. 4.8 Pas with comparable PWP/MWCO values as shown in the comparative examples 2-6 in Table 2, where NMP is used as solvent. The magnitude of Emod and Strain@break by using NMP as solvent are all lower independent of the viscosity amounts. The PWP and MWCO values cannot be amended even if the viscosity is increasing. Compared to NBP as closest state of the art (comparative examples 7 to 11) TBP polymer solutions show higher viscosities and deliver more stable membranes according to tensile testing (Emod and Strain@break). Also, with NBP the PWP and MWCO values cannot be amended.

TABLE 3
Compositions and properties of Ultrason ® S 6010 solutions; turbidity@RT [NTU],
Visco@60° C. [Pas],

| | | Solvent | | NTU | NTU | NTU | NTU | NTU | NTU |
|---|---|---|---|---|---|---|---|---|---|
| example | S6010 | S1 | Visco | (0 d) | (14 d) | (21 d) | (28 d) | (35 d) | (42) |
| example 7 | 25 g | 75 g TBP | 9.8 | 1.52 | 1.47 | 1.44 | 1.51 | 1.55 | 1.55 |
| comp. ex12 | 25 g | 75 g DMF | 2.3 | 2.11 | 2.76 | 4.15 | 6.20 | 10.4 | 17.3 |

Insoluble crystalline cyclic polysulfone dimers pose in solutions for membrane manufacturing problems either by filter clogging or can cause imperfections on the membrane surface (S. Savarier et. al, Desalination 2002, 144, 15-20). Polymer solutions of S6010 in TBP are clearer and more transparent compared to solutions in DMF over time. The content of cyclic dimers is better dissolved by TBP compared to DMF as shown by solution turbidity. Over time the solution turbidity increases in DMF while in TBP it remains stable.

TABLE 4
Compositions and properties of Ultrason ® S 6010 membranes
prepared; MWCO in [kDa], PWP in [kg/h m2 bar], Visco@60°
C. [Pas], turbidity@60° C. [NTU], Posttreatment B (water wash). Coagulation Water

| | additive | S6010 | Solvent S1 | NTU | visco | PWP | MWCO |
|---|---|---|---|---|---|---|---|
| example | 8 g Pluriol 400 E | 16.3 g | 75.7 g TBP | 3.21 | 1.30 | 178 | 9.7 |
| 8 | | | | | | | |
| comp. | 8 g Pluriol 400 E | 16.3 g | 75.7 g DMF | 3.76 | 0.25 | 75 | 10.5 |
| ex. 13 | | | | | | | |
| example | 8 g Pluriol 9000 E | 16.3 g | 75.7 g TBP | 2.81 | 1.68 | 632 | 15.7 |
| 9 | | | | | | | |
| comp. | 8 g Pluriol 9000 E | 16.3 g | 75.7 g DMF | 37.3* | 0.05 | — | — |
| ex. 14 | | | | | | | |
| example | 8 g Breox 75W55 | 16.3 g | 75.7 g TBP | 4.85 | 1.30 | 1311 | 85.0 |
| 10 | | | | | | | |
| comp. | 8 g Breox 75W55 | 16.3 g | 75.7 g DMF | 1982* | — | — | — |
| ex. 15 | | | | | | | |

*two-phase system: no membranes could be manufactured

TABLE 5
Compositions and properties of Ultrason ® P3020P
solutions; turbidity@RT [NTU], Visco@60° C. [Pas],

| example | E3010 | Solvent S1 | | Visco | NTU |
|---|---|---|---|---|---|
| example 10 | 20 g | 80 | g TBP | 2.80 | 36.3 |
| comp. ex. 16 | 20 g | 80 | g DMF | 0.55 | 1070 |

TABLE 6
Compositions and properties of Ultrason ® P3020P
membranes prepared; MWCO in [kDa], PWP in
[kg/h m2 bar], Visco@60° C. [Pas],
Posttreatment A (NaOCl). Coagulation water-glycerol (50/50 wt/wt)

| example | P3020P | K30 | K90 | Solvent S1 | Visco | PWP | MWCO |
|---|---|---|---|---|---|---|---|
| example 11 | 19 g | 3 g | 3 g | 75 g TBP | 39.7 | 540 | 30.0 |
| comp. ex. 17 | 19 g | 3 g | 3 g | 75 g DMF | ** | — | — |

** polymers not soluble: no membranes could be manufactured

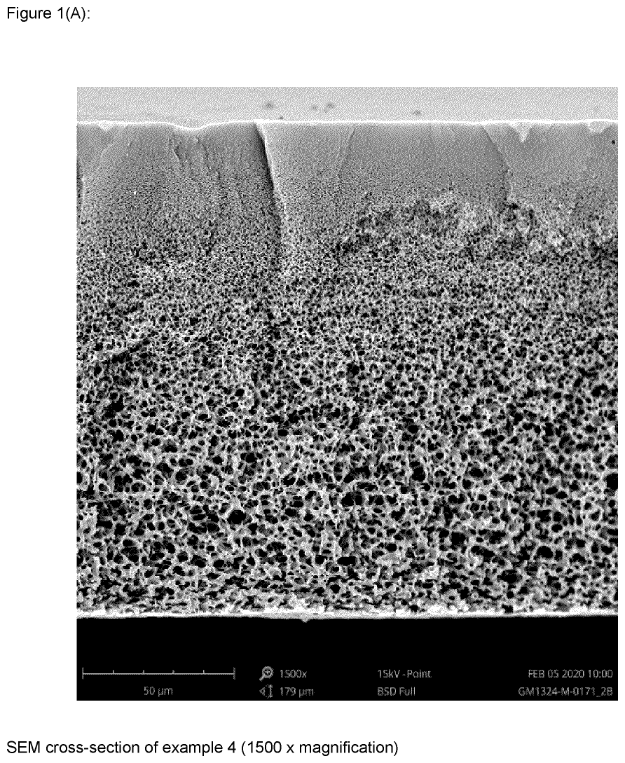

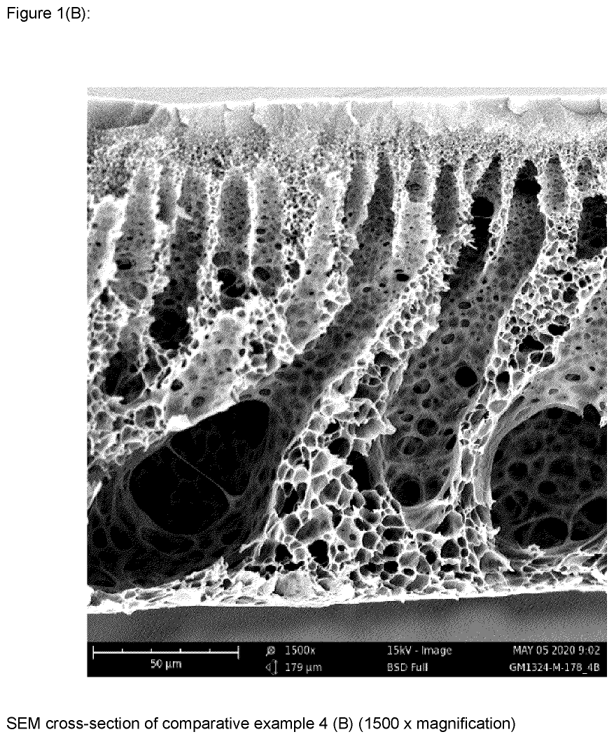

FIG. 1(A) shows a scanning electron micrograph of a membrane of example 4 according to the invention which shows a well-established nano porous filtration layer on the top supported by a sponge-type substructure with increasing pore sizes from top to bottom. No defects or macrovoids are visible in die cross-section. FIG. 1(B) shows a scanning electron micrograph of a membrane of comparative example 4 showing numerous macrovoids which could partially penetrate the filtration layer on the top and cause reduced mechanical stability as seen from the results of the tensile testing.

Polymer solutions produced with TBP according to the invention and membranes fabricated thereof showed improved mechanical stability (higher Emodulus) over membranes produced from NBP/2P (10/90-90/10 wt/wt) and TBP/2P (10/90-90/10 wt/wt) mixtures as solvents as described in EP-A 3756753. Also, the membrane produced from TBP solution showed a higher permeability value of 870 kg/h m²bar compared to membranes produced from TBP/2P (10/90 90/10 wt/wt) mixtures with 290-740 kg/h m²bar. The membrane produced with TBP showed similar separation characteristics taking the MWCO value of 64.4 kDa into account (TBP/2P 10/90-90/10 wt/wt mixtures: 17.8-34.2 kDa). In general, MWCO values of 10-100 kDa account for the ultrafiltration range.

TABLE 1
Compositions and properties of Ultrason ® E 3010 membranes prepared
with 19 g E3010, 3 g K30, 3 g K90 and 10 g 1,2-propandiol; MWCO in [kDa],
PWP in [kg/h m2 bar], Visco@60° C. [Pas], Emodulus [MPa],
Strain@break [%] Posttreatment A NaOCl. Coagulation water-glycerol (50/50 wt/wt)

| | | | | | | | | Strain |
|---|---|---|---|---|---|---|---|---|
| example | 2P | NBP | TBP | Visco | PWP | MWCO | Emod | @break |
| example 3 | — | — | 65 g | 18.2 | 870 | 64.6 | 172 ± 6 | 26 ± 3 |
| comp. ex. | 58.5 g | 6.5 g | — | 34.1 | 330 | 15.8 | 96 ± 4 | 28 ± 17 |
| 18 | | | | | | | | |
| comp. ex. | 32.5 g | 32.5 g | — | 23.2 | 770 | 29.6 | 126 ± 3 | 28 ± 9 |
| 19 | | | | | | | | |
| comp. ex. | 6.5 g | 58.5 g | — | 18.3 | 1366 | 95.0 | 143 ± 3 | 15 ± 26 |
| 20 | | | | | | | | |
| example 12 | 58.5 g | — | 6.5 g | 35.3 | 290 | 17.8 | 83 ± 3 | 27 ± 8 |
| example 13 | 32.5 g | — | 32.5 g | 26.0 | 560 | 23.7 | 133 ± 1 | 25 ± 5 |
| example 14 | 6.5 g | — | 58.5 g | 22.4 | 740 | 34.2 | 156 ± 5 | 24 ± 17 |

1: A solution, comprising
a sulfone polymer selected from the group consisting of
a polyethersulfone of formula I, 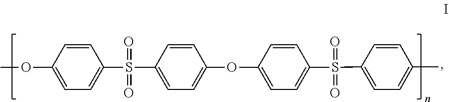
a polysulfone of formula II, 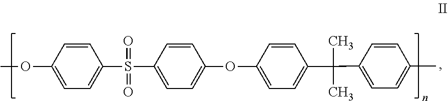
and
polyphenylsulfone of formula III, 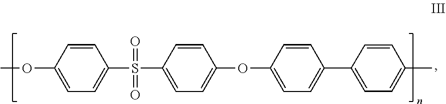
wherein an average molecular weight Mw of the sulfone polymers
is in the range from 40000 to 95000 g/mol, and
N-tert.-butyl-2-pyrrolidone, as the only solvent used.

2: The solution according to claim 1, wherein the sulfone polymer comprises at least 0.02 mol —SO2- units per 100 g of the sulfone polymer.

3: The solution according to claim 1, wherein the sulfone polymer is an aromatic sulfone polymer which comprises at least 30 wt.-% of aromatic carbon atoms, based on a total weight amount of the sulfone polymer.

4: The solution according to claim 1, comprising:
at least one of the sulfone polymer,
at least one water soluble polymer, and
the N-tert-butyl-2-pyrrolidone as the only solvent used.

5: The solution according to claim 1, comprising:
at least one of the sulfone polymer,
an additive, and
the N-tert.-butyl-2-pyrrolidone as the only solvent used.

6: The solution according to claim 4, wherein the solution further comprises art additive.

7: The solution according to claim 5, wherein the additive is selected from the group consisting of C2-C4 alkanol, C2-C4 alkanediol, C3-C4 alkanetriol, polyethylene oxide with a molar mass below 200 g/mol, and a mixture thereof.

8: The solution according to claim 1, wherein the solution comprises 1 to 40 wt-% of the sulfone polymer, based on the solution.

9: The solution according to claim 4, wherein the solution comprises 0.1 to 15 wt.-% of the at least one water soluble polymer, based on the solution.

10: The solution according to claim 5, wherein the solution comprises 0.1 to 15 wt.-% of the additive, based on the total weight amount of the solution.

11: A process, comprising:
making a membrane with the solution according to claim 4.

12: The process of claim 11, comprising:
a) providing the solution,
b) contacting the solution with at least one coagulant, and
c) optionally, oxidizing and washing the obtained membrane.

13: The process according to claim 12, wherein the at least one coagulant comprises water or vapor.

14: A membrane, obtained by the process according to claim 11.

15: A process, comprising:
separating components in a fluid with the membrane according to claim 14, wherein the process is for water treatment applications, treatment of industrial or municipal waste water, desalination of sea or brackish water, dialysis, plasmolysis, or food processing.

16: The solution according to claim 6, wherein the additive is selected from the group consisting of C2-C4 alkanol, C2-C4 alkanediol, C3-C4 alkanetriol, polyethylene oxide with a molar mass below 200 g/mol, and a mixture thereof.

17: The solution according to claim 6, wherein the solution comprises 0.1 to 15 wt.-% of the additive, based on the total weight amount of the solution.
